(19) United States
(12) Patent Application Publication
(10) Pub. No.: US 2016/0305372 A1
(43) Pub. Date: Oct. 20, 2016

(54) SYSTEM AND METHOD FOR HYDROGEN BASED ENGINE DECARBONIZATION

(71) Applicant: NEUTRINOS ENGINEERING SDN. BHD., Johor Bahru, Johor (MY)

(72) Inventor: Ying Lee LOW, Singapore (SG)

(73) Assignee: NEUTRINOS ENGINEERING SDN. BHD., Johor Bahru, Johor (MY)

(21) Appl. No.: 15/034,514

(22) PCT Filed: Oct. 31, 2014
(86) PCT No.: PCT/SG2014/000512

§ 371 Date: May 4, 2016

(30) Foreign Application Priority Data
Nov. 5, 2013 (SG) 2013081060
Apr. 25, 2014 (SG) 10201401822Y

(51) Int. Cl. F02M 25/12; B08B 5/00; B08B 9/08; F02B 77/04

(52) U.S. Cl. CPC F02M 25/12; F02B 77/04; B08B 5/00; B08B 9/08

(57) ABSTRACT

An engine decarbonization system includes multiple local engine decarbonization units that communicate with a remote engine decarbonization management system. Each engine decarbonization unit includes a hydrogen flow regulation unit couplable to a source of dry hydrogen; a hydrogen delivery line for introducing dry hydrogen into an engine; an engine exhaust gas analyzer for measuring engine exhaust gas components and determining a set of corresponding lambda values; and a control unit configured for controllably introducing dry hydrogen into the engine while the engine is running in accordance with a set of engine decarbonization process parameters, which can be provided or determined by the remote engine decarbonization management system based upon engine type and engine capacity. Each engine decarbonization unit introduces dry hydrogen rate into a given engine such that determined lambda values corresponding to engine combustion conditions approach or remain within a target lambda value range.

### TECHNICAL FIELD

The present disclosure relates generally to systems and methods for decarbonizing engines using hydrogen. Specific aspects of the present disclosure are directed to an automated system and process for engine decarbonization by way of computer controlled flow of hydrogen from a solid state/dry hydrogen source into an air intake pathway of an engine in conjunction with real-time monitoring of engine exhaust gas components and/or parameters (e.g., air-to-fuel ratio, or lambda) to provide decarbonization process feedback.

### BACKGROUND

Internal combustion engines operate by way of burning a fuel (e.g., a petroleum or hydrocarbon based fuel) in the presence of an oxidant inside a combustion chamber, resulting in the transformation of the fuel into other chemical species or combustion products, and the production of mechanical and thermal energy. Under idealized, perfectly efficient hydrocarbon combustion conditions, the hydrocarbon fuel would be entirely burned, and the combustion products would be CO₂ and H₂O. Unfortunately, internal combustion engines operate with (quite) limited efficiency. Consequently, incomplete combustion byproducts are produced within the combustion chamber. Over time, incomplete combustion byproducts are deposited as carbon, carbon based, carbon like, or carbon-type substances on various internal surfaces within an engine unit that are exposed to combustion gases (e.g., piston heads, cylinder surfaces, engine valve surfaces, and exhaust pathway surfaces), which can adversely affect engine efficiency and/or performance.

Multiple engine “decarbonization” or “decarburization” techniques exist, which are directed to at least partially removing incomplete combustion byproducts that have been deposited on internal engine surfaces. For instance, particular chemical substances that are known to react with or liquefy various types of hydrocarbon deposits can be combined with or added to an engine's fuel or oil, such that during engine operation these added chemical substances react with and at least partially remove (e.g., gradually dissolve) engine deposits. Another decarbonization approach, which may be more effective as well as more environmentally friendly, is intentionally introducing hydrogen into the engine's combustion chamber during engine operation. The introduced hydrogen reacts with combustion byproduct deposits present on internal engine surfaces to create chemical species which are evacuated from the engine unit with normal exhaust flow.

Existing hydrogen based decarbonization systems utilize hydrogen produced by way of electrolysis of water, that is, the decomposition of H₂O into H₂ and O₂ by an electrical current. Such hydrogen can be referred to as “oxyhydrogen” or “wet hydrogen.” More specifically, existing Hydrogen based decarbonization systems typically include a water reservoir through which an electrical current is passed in order to generate oxyhydrogen. The oxyhydrogen is supplied to an air intake pathway of the engine (e.g., via a conventional exhaust gas recirculation hose, a vacuum hose associated with a brake system vacuum port or hose, or another pathway) for a predetermined amount of time based upon engine capacity (e.g., 20 minutes or 40 minutes), after which the engine is deemed “decarbonized.”

While conventional decarbonization systems and techniques provide a given degree of engine efficiency and/or performance restoration, such systems and techniques fail to provide adequate information about whether an engine has actually been decarbonized in an effective, near-optimal, or expected optimal manner. A need exists for an improved engine decarbonization system and technique.

### SUMMARY

Various embodiments in accordance with the present disclosure are directed to system architectures, systems, apparatuses, units, devices, processes, and modules (e.g., software or program instruction modules) for controllably performing decarbonization or decarburization processes on one or more types of internal combustion engines by way of introducing hydrogen (e.g., provided from at least one solid-state hydrogen source) into the engines, in association with decarbonization process monitoring and/or feedback control, for instance, on a real-time, near-real-time or periodic basis (e.g., at regularly sampled intervals) based upon measurements of one or more exhaust gas components and/or parameters (e.g., air-to-fuel ratio, or lambda). Engines that can undergo decarbonization processes in accordance with embodiments of the present disclosure typically correspond to essentially any type of ground-based transportation vehicle such as passenger automobiles, taxi cabs, trucks/lorries, or motorcycles/motorbikes/ scooters/all-terrain vehicles, but can additionally or alternatively correspond to essentially any other type of machine (e.g., a piston-based internal combustion engine aircraft, a lawnmower, or other type of machine) having an engine in which carbon, carbon-based, carbon-like, or hydrocarbon based materials or substances are deposited or build up over time as a result of incomplete/inefficient combustion.

In accordance with an aspect of the present disclosure, a process for decarbonizing engines includes determining an initial set of first engine decarbonization process parameters corresponding to a first engine; and performing a first engine decarbonization process upon the first engine, the first engine decarbonization process including: introducing dry hydrogen into the first engine while the first engine is running, in accordance with the initial set of first engine decarbonization process parameters; automatically measuring first engine exhaust gas components while dry hydrogen is introduced into the first engine; and automatically determining a set of lambda values based upon the measured exhaust gas components while dry hydrogen is introduced into the first engine, each lambda value corresponding to an air-to-fuel ratio for the first engine.

In multiple embodiments, introducing dry hydrogen into the first engine means releasing dry hydrogen from a dry hydrogen source into the first engine, rather than introducing oxyhydrogen into the first engine.

The initial set of engine decarbonization process parameters includes a dry hydrogen flow rate, pressure, and/or volume, and can additionally or alternatively include a first time period based upon first engine type, first engine capacity, first engine odometer reading, and/or a set of preliminary lambda values corresponding to the first engine.

The process can include adjusting a flow rate of dry hydrogen sourced from a dry hydrogen source to establish an initial dry hydrogen flow rate or pressure in accordance with the initial set of first engine decarbonization parameters. The process can also include determining a temperature of a dry hydrogen source from which the dry hydrogen is introduced into the first engine; and adjusting the temperature of the dry hydrogen source before and/or during the first engine decarbonization process to establish or maintain a dry hydrogen flow rate or pressure in accordance with the initial set of first engine decarbonization process parameters.

The process can also include determining an updated set of first engine decarbonization process parameters based upon at least some of the determined lambda values; and continuing the first engine decarbonization process by introducing dry hydrogen into the first engine in accordance with the updated set of first engine decarbonization process parameters. Continuing the first engine decarbonization process in accordance with the updated set of first engine decarbonization parameters can shift first engine combustion conditions such that determined lambda values are at least approaching a target lambda value range, or remain within the target lambda value range.

The updated set of first engine decarbonization process parameters can include an updated dry hydrogen flow rate or pressure. The updated set of first engine decarbonization process parameters can additionally or alternatively includes second time period based upon first engine type, first engine capacity, first engine odometer reading, and/or one or more determined lambda values determined during introduction of dry hydrogen into the first engine in accordance with the initial set of first engine decarbonization process parameters.

Determining the initial set of first engine decarbonization process parameters for the first engine decarbonization process can include: receiving at a remote engine decarbonization management system first engine information including one or more of first engine type, first engine capacity, first engine odometer reading, and a set of preliminary lambda values determined for the first engine; automatically determining the initial set of first engine decarbonization process parameters by the remote engine decarbonization management system in accordance with the first engine information; and automatically communicating the initial set of first engine decarbonization process parameters from the remote engine decarbonization management system to a first local engine decarbonization unit configured for introducing dry hydrogen into the first engine in accordance with the initial set of first engine decarbonization process parameters and measuring first engine exhaust gas components.

The process can further include performing a second engine decarbonization process upon a second engine, the second engine decarbonization process including: determining an initial set of second engine decarbonization process parameters; introducing dry hydrogen into the second engine while the second engine is running, in accordance with the initial set of second engine decarbonization process parameters; measuring second engine exhaust gas components while dry hydrogen is introduced into the second engine; and determining a set of lambda values based upon the measured exhaust gas components while dry hydrogen is introduced into the second engine, each lambda value corresponding to an air-to-fuel ratio for the second engine. Introducing dry hydrogen into the second engine and measuring second engine exhaust gas components is performed by a second local engine decarbonization unit distinct from the first local engine decarbonization unit. The first and second engine decarbonization procedures can be performed simultaneously.

In some embodiments, the first local engine decarbonization unit stores a first authorization code and the second local engine decarbonization unit stores a second authorization code. Each of the first and second authorization codes is communicable to the remote decarbonization management system for automatic verification of the first local engine decarbonization unit and the second local engine decarbonization unit, respectively, by the remote decarbonization management system.

The process can further include storing in a database associated with the remote engine decarbonization management system historical engine decarbonization information. The process can also include providing an Internet based vehicle manufacturing interface by which a vehicle manufacturer can access decarbonization process histories corresponding to vehicles they have manufactured, and/or categorical types of vehicles they and/or other manufacturers have manufactured.

In accordance with an aspect of the present disclosure, a system for decarbonizing engines includes a set of engine decarbonization units, each engine decarbonization unit including: a hydrogen flow regulation unit couplable to a source of dry hydrogen; a hydrogen delivery line coupled to the hydrogen flow regulator and configured for introducing dry hydrogen into an engine; an engine exhaust gas analyzer configured for measuring engine exhaust gas components and determining a set of corresponding lambda values, each lambda value corresponding to an air-to-fuel ratio of the engine; and a control unit configured for controllably introducing dry hydrogen into the engine while the engine is running in accordance with an initial set of engine decarbonization process parameters, wherein the initial set of engine decarbonization process parameters is based upon at least some of engine type, engine capacity, engine odometer reading, and a set of preliminary lambda values corresponding to the engine.

The control unit of each engine decarbonization unit can further be configured for adjusting a dry hydrogen flow rate into the engine in order to shift engine combustion conditions such that determined lambda values are at least approaching a target lambda value range, or remain within the target lambda value range.

Each engine decarbonization unit can include a set of temperature sensors and a temperature regulation device for controlling a temperature of the source of dry hydrogen.

In various embodiments, the set of engine decarbonization units includes a plurality of engine decarbonization units, and the system further includes a remote engine decarbonization management system configured for network communication with each engine decarbonization unit, the network communication involving: communicating from each engine decarbonization unit to the remote engine decarbonization management system a set of lambda values corresponding to an engine associated with the engine decarbonization unit and undergoing a decarbonization process; and communicating from the remote engine decarbonization management system to each engine decarbonization unit a set of updated engine decarbonization process parameters specifying a dry hydrogen flow rate, pressure, and/or volume for shifting combustion conditions of the engine associated with the engine decarbonization unit such that determined lambda values for the engine are at least approaching a target lambda value range, or remain within the target lambda value range.

The network communication can additionally or alternatively involve: communicating to the remote engine decarbonization management system engine information including one or more of engine type, engine capacity, engine odometer reading, and a set of preliminary lambda values corresponding to the engine associated with the engine decarbonization unit; and communicating from the remote engine decarbonization management system to each engine decarbonization unit a set of initial engine decarbonization process parameters based upon the engine information.

The remote engine decarbonization management system can be configured for verifying an authorization code corresponding to each engine decarbonization unit.

The system can include a database coupled to the remote engine decarbonization management system, such that the remote engine decarbonization management system is configured to store engine decarbonization histories corresponding to different types of engines in the database. In some embodiments, the remote engine decarbonization management system provides an Internet based vehicle manufacturing interface by which a vehicle manufacturer can access decarbonization process histories corresponding to vehicles they have manufactured, and/or categorical types of vehicles they and/or other manufacturers have manufactured.

In accordance with an aspect of the present disclosure, a system for decarbonizing engines includes a set of engine decarbonization units, each engine decarbonization unit including: a hydrogen flow regulation unit couplable to a source of dry hydrogen (e.g., a source of hydrogen other than oxyhydrogen); a hydrogen delivery line coupled to the hydrogen flow regulator and configured for introducing dry hydrogen into an engine; an engine exhaust gas analyzer configured for measuring engine exhaust gas components and determining a set of corresponding lambda values, each lambda value corresponding to an air-to-fuel ratio of the engine; and a control unit configured for controllably introducing dry hydrogen into the engine while the engine is running in accordance with a set of engine decarbonization process parameters, wherein the set of engine decarbonization process parameters is based upon at least one of engine type, engine capacity, engine odometer reading, and a set of lambda values corresponding to the engine.

Each engine decarbonization unit can further include a set of temperature sensors and a temperature regulation device for controlling a temperature of the source of dry hydrogen. The source of dry hydrogen for each engine decarbonization unit can include or be a set of solid state hydrogen gas canisters, cartridges, and/or cassettes, and wherein each engine decarbonization unit further comprises a housing configured for removably receiving the set of solid state hydrogen gas canisters/cartridges/cassettes and coupling the set of solid state hydrogen gas canisters/cartridges/cassettes to the hydrogen flow regulation unit.

Each engine decarbonization unit can additionally or alternatively include a display device, and/or at least one digital code reader (e.g., which can include or be a QR code reader). The system can include a decarbonization facility computer system having at least one digital code generation unit (e.g., which can include or be a QR code generation unit).

The set of engine decarbonization units can include a plurality of engine decarbonization units, for instance, a first set of engine decarbonization units located at a first decarbonization facility, and a second set of engine decarbonization units located at a second decarbonization facility that is geographically distinct from the first engine decarbonization facility; and the system can include a remote engine decarbonization management system coupled to each engine decarbonization unit by way of a computer network. The system can additionally include a database coupled to the remote engine decarbonization management system, the database storing engine decarbonization history information (e.g., decarbonization history information/data associated with each of the first set of engine decarbonization units and the second set of engine decarbonization units). The system can also include a first network gateway corresponding to the first decarbonization facility and configured for communication with the first set of engine decarbonization units and the remote engine decarbonization management system; and a second network gateway corresponding to the second decarbonization facility and configured for communication with the second set of engine decarbonization units and the remote engine decarbonization management system.

### BRIEF DESCRIPTION OF THE DRAWINGS

FIG. 1 is a schematic illustration of an engine decarbonization system architecture in accordance with an embodiment of the disclosure.

FIG. 2 is a schematic illustration showing portions of a decarbonization system architecture in accordance with an embodiment of the present disclosure, in which an engine decarbonization unit associated with a decarbonization facility, location, or service station is configured for performing an engine decarbonization process on an automobile engine.

FIG. 3 is a block diagram showing portions of a local control unit for an engine decarbonization unit in accordance with an embodiment of the present disclosure.

FIGS. 4A-4B are representative illustrations showing portions of a decarbonization process graphical user interface (GUI) in accordance with an embodiment of the present disclosure.

### DETAILED DESCRIPTION

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. The recitation of a particular numerical value or value range herein is understood to include or be a recitation of an approximate numerical value or value range (e.g., within +/−20%, +/−10%, +/−5%, +/−2%, or +/−1%).

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, an object, a process, a physical parameter, or a value depending upon the type of set under consideration.

Aspects of a Representative Engine Decarbonization System Architecture

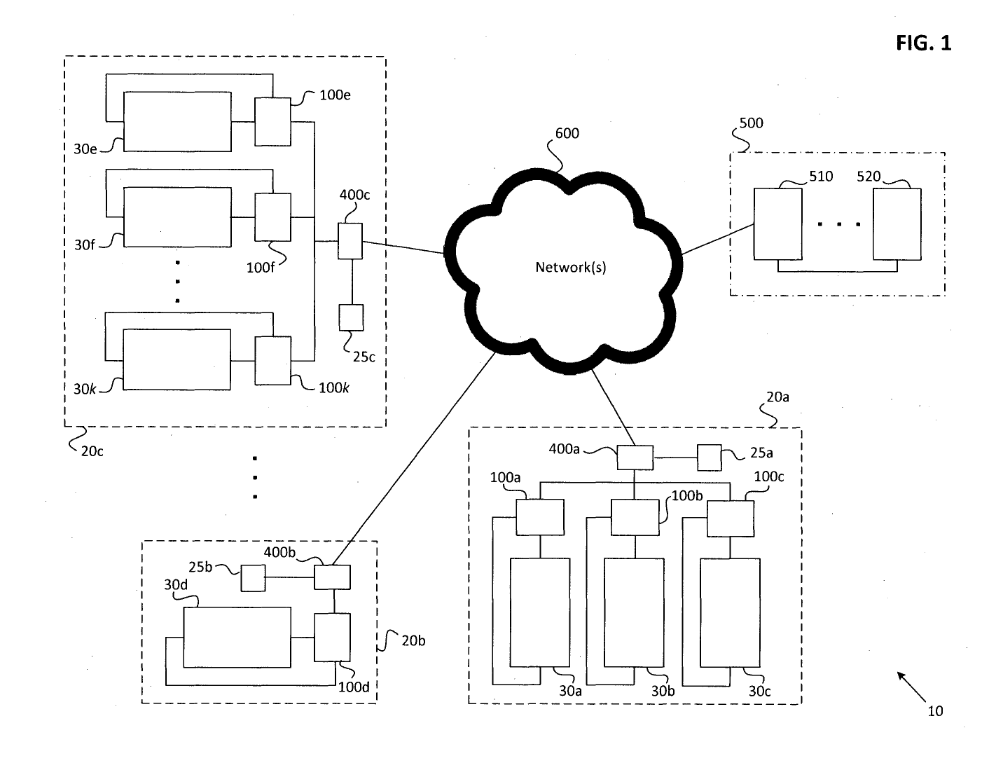

FIG. 1 is a schematic illustration of a representative engine decarbonization or decarburization system architecture 10 in accordance with an embodiment of the disclosure. In an embodiment, the engine decarbonization system architecture 10 includes at least one, and typically multiple (e.g., several or many) engine decarbonization or decarburization or units 100, each of which is associated with (e.g., located or accessible within) an engine decarbonization or decarburization facility, location, site, or service station 20a-c. A decarbonization facility 20 can perform decarbonization services on a predetermined number of engines 30 (e.g., vehicle engines), where each decarbonization service involves a decarbonization service routine or procedure that includes at least one decarbonization process or cycle, at any given time depending upon the number of engine decarbonization units 100 associated therewith or disposed therein, as further detailed below. Each decarbonization facility 20 can include at least one decarbonization facility computer system 25 (e.g., which includes a desktop, laptop, or tablet computer and a printer associated with a facility service desk), at which the owners of vehicles or machines who visit the decarbonization facility can communicate with decarbonization facility service personnel to check-in, register, and pay for a decarbonization process.

An engine decarbonization unit 100 is configured or configurable for controllably introducing or delivering hydrogen, which in various embodiments includes or is dry hydrogen provided, released, or releasable from a solid-state or dry hydrogen source such as a solid-state hydrogen cell, container, or canister, into an engine 30 during an engine decarbonization process. That is, in various embodiments, an engine decarbonization unit 100 is configured for introducing dry hydrogen sourced from a solid-state (e.g., metal hydride) hydrogen storage unit or device, rather than oxyhydrogen produced by way of electrolysis of water, into an engine 30. The controlled introduction of dry hydrogen, rather than oxyhydrogen, into an engine 30 during a decarbonization process can facilitate more predictable, more reliable, more controllable, and/or improved decarbonization process results (e.g., more controllable and/or more efficacious decarbonization process results relative to a given decarbonization process time). Each engine decarbonization unit 100 is further configured or configurable for monitoring, sampling, and/or analyzing engine exhaust gas components and/or parameters at one or more times (e.g., on a real-time or near-real-time basis) before, during, and/or after a decarbonization process, which can provide an indication of decarbonization process progress or efficacy and/or engine combustion efficiency at one or more times (e.g., indicating a change in engine combustion efficiency during or as a result of a decarbonization process).

In several embodiments, at least some engine decarbonization units 100 are additionally configured for wire-based and/or wireless information transfer, exchange, or communication with at least one remote computer system 500 by way of one or more communication networks 600 such as the Internet, where the remote computer system 500 is configured or configurable for authorizing, monitoring, managing, and/or controlling individual decarbonization service routines and/or processes performed by engine decarbonization units 100 that can communicate therewith. In the description that follows, such a remote computer system 500 is referred to as a remote decarbonization management system 500 for purpose of simplicity and to aid clarity. Network communication or information exchange/transfer between the remote decarbonization management system 500 and a local decarbonization unit 100 associated with a particular decarbonization facility 20 can involve a network gateway system, apparatus, or device 400 by which such network communication occurs. The decarbonization management system 500 can include a set of servers 510 (e.g., one or more cloud-based servers) for determining one or more sets of decarbonization process parameters and/or analyzing decarbonization process data or progress, as well as at least one database 520 in which decarbonization related information, including vehicle/engine information (e.g., owner information, engine type, and current odometer reading) and associated decarbonization process results/history, are stored or storable, as further detailed below.

The representative decarbonization system architecture 10 of FIG. 1 includes a plurality of decarbonization facilities 20, namely, at least a first, a second, and a third decarbonization facility 20a-c, where each decarbonization unit 100 in each such facility 20 is configured for network-based (e.g., Internet-based) communication with a remote decarbonization management system 500. In other embodiments, one or more decarbonization units 100 can function independently of and need not communicate with a remote decarbonization management system 500. Depending upon embodiment details, the decarbonization system architecture 10 can include fewer or additional (e.g., many) decarbonization facilities 20, which can be geographically distributed in or across various locations (e.g., different cities and/or countries).

A decarbonization system architecture 10 in accordance with an embodiment of the present disclosure can exhibit a wide variety of configurations. In the embodiment shown, which provides as a non-limiting illustration of a representative decarbonization system architecture 10, the first decarbonization facility 20a includes a first, a second, and a third decarbonization unit 100a-c. The first engine decarbonization unit 100a can perform a decarbonization process on a first engine 30a, for instance, corresponding to a first machine or vehicle. Simultaneously or separately, the second engine decarbonization unit 100b can perform a decarbonization process on a second engine 30b corresponding to a second vehicle; and/or the third engine decarbonization unit 100c can perform a decarbonization process on a third engine 30c corresponding to a third vehicle. Analogously, a second decarbonization facility 20b includes a single or fourth engine decarbonization unit 100d, which can perform a decarbonization process on an engine 30d corresponding to a fourth machine or vehicle. Further analogously, a third decarbonization facility 20c includes a fifth through a kth engine decarbonization unit 100e-k, which can correspondingly perform a decarbonization process on a fifth through a kth engine 30e-k, respectively, in a manner readily understood by one having ordinary skill in the relevant art in view of the description herein.

Aspects of a Representative Engine Decarbonization Unit

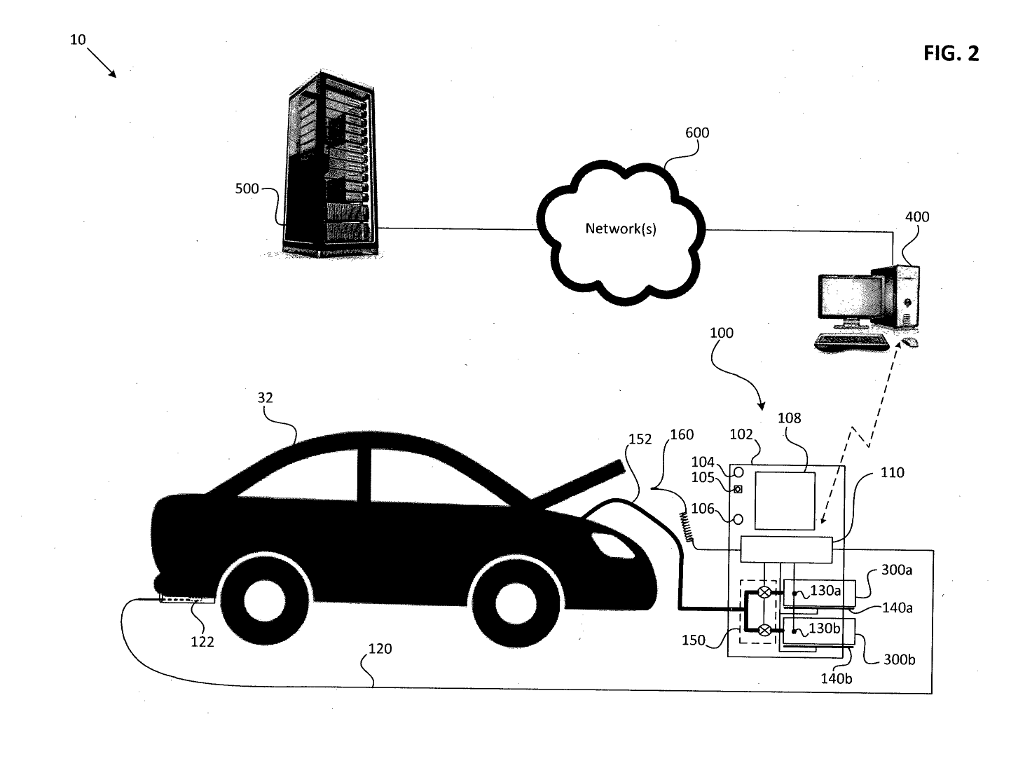

FIG. 2 is a schematic illustration showing portions of a decarbonization system architecture 10 in accordance with an embodiment of the present disclosure, in which a given engine decarbonization unit 100 associated with a particular decarbonization location, facility, or service station 20 is configured or configurable for performing an engine decarbonization process on an engine 30 of a machine or vehicle 32 such as an automobile. In an embodiment, the engine decarbonization unit 100 includes a housing 102 that carries a local controller or control unit 110, a set of hydrogen gas canisters, cartridges, and/or cassettes 300a-b, a hydrogen flow control/regulation unit 150, and other elements that facilitate the performance of engine decarbonization processes by way of the controlled release of hydrogen gas from the hydrogen gas canisters/cartridges/cassettes 300a-b and the introduction of such hydrogen gas into the engine 30, as further detailed hereafter.

The local control unit 110 is configured for controllably releasing hydrogen gas stored within the set of solid state hydrogen gas canisters/cartridges/cassettes 300a-b and delivering such hydrogen gas into the engine 30 of the automobile 32 while the engine 30 is running (e.g., under idle, moderately high idle, or high idle conditions) by way of the hydrogen flow control/regulation unit 150 and a hydrogen delivery line or tube 152. The hydrogen delivery line 152 can be coupled to a pathway by which a gas can be introduced or drawn into the automobile's engine 30. Such a pathway can include or be, for instance, a brake system vacuum pipe, line, hose, or port; or an exhaust gas recirculation (EGR) line, hose, or port. The manner in which the hydrogen delivery line 152 is coupled to an engine air intake pathway can depend upon the type of engine 30 and/or vehicle 32 under consideration (e.g., a gasoline/petrol engine, versus a diesel engine), in a manner readily understood by one having ordinary skill in the relevant art.

In various embodiments, the local control unit 110 is additionally configured for monitoring or sensing a temperature associated with one or more hydrogen gas canisters/cartridges/cassettes 300a-b by way of a set of temperature sensors 130a-b, and can also be configured for controlling or regulating a temperature associated with the hydrogen gas canister(s) 130a-b by way of one or more types of temperature regulation elements or devices 140a-b to facilitate the predictable or controlled release of hydrogen from the hydrogen gas canisters/cartridges/cassettes 300a-b. The local control unit 110 is also configured for monitoring, sampling, and/or analyzing particular engine exhaust gases by way of an exhaust sensor/analyzer coupled to an exhaust sampling pipe, tube, hose, or line 120 having a tip or end portion 122 that is insertable into an engine's exhaust pathway (e.g., a vehicle tailpipe), through which exhaust gases can be drawn and sampled or monitored.

The local control unit 110 can optionally be configured for capturing images of internal engine surfaces or spaces, such as images (e.g., before/after decarbonization process images) showing engine combustion chamber surfaces (e.g., cylinder surfaces and piston heads), by way of a conventional borescope/endoscope or other type of image capture device 160, in a manner readily understood by one having ordinary skill in the relevant art. Finally, the local control unit 110 is configured for data communication with a remote decarbonization management system 500 coupled to the Internet 600 by way of a network gateway 400 corresponding to the decarbonization facility 20 with which the local control unit 110 is associated.

The engine decarbonization unit's housing 102 carries a number of user interface elements, devices, and/or controls, such as an on/off switch or button 104; possibly a machine readable code capture device 105 such as a camera that can capture a quick response (QR) code and/or other type of information encoded image; an emergency shut-off (ESO) switch or button 106, and a display device 108 by which service personnel associated with the decarbonization facility 20 can interact with the engine decarbonization unit 100. In certain embodiments, the engine decarbonization unit 100 can include one or more additional or other user interface elements, devices, or controls, such as a keyboard.

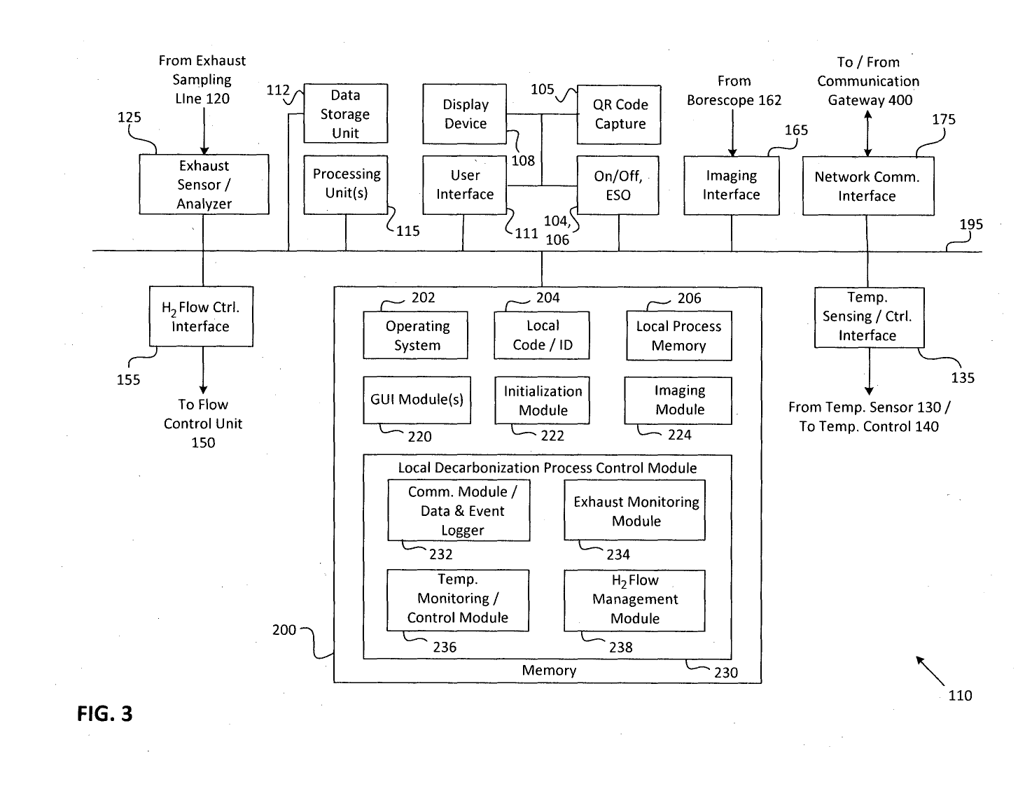

FIG. 3 is a block diagram showing portions of a local control unit 110 for an engine decarbonization unit 100 in accordance with an embodiment of the present disclosure. In an embodiment, the local control unit 100 includes a user interface 111 coupled to the on/off switch 104, the QR code capture device 105, the ESO switch 106, the display device 108, and possibly one or more other user interface/control elements or devices (e.g., a keyboard); a data storage unit 112; at least one processing unit 115; a network communication interface 175 configured for data communication with the remote decarbonization process manager 500 by way of the network gateway 400; an exhaust sensor/analyzer 125 coupled to the exhaust sensing line 120; a temperature sensing and/or control interface 135 coupled to the temperature sensor(s) 130; a hydrogen flow control interface 155 coupled to the hydrogen flow control unit 150; and optionally an imaging interface 165 coupled to the optional borescope and/or another type of imaging device 160. Each of the aforementioned interfaces includes conventional circuitry, electronics, and/or ports for facilitating signal or data transfer, exchange, communication, in a manner readily understood by one having ordinary skill in the relevant art.

The local control unit 110 further includes a memory 200 for storing data as well as software modules or program instruction sets executable by the processing unit(s) 115 for managing, monitoring, controlling, or performing aspects of an engine decarbonization service routine and/or process. In an embodiment, the memory 200 includes an operating system 202; a local engine decarbonization unit authorization code or identifier (ID) memory 204 for storing a local authorization code or ID; a local decarbonization process memory 206 for storing signals and/or data relating to or generated in association with or during a decarbonization service routine and/or decarbonization process; a set of decarbonization process Graphical User Interface (GUI) modules 220; an initialization module 222; an optional imaging module 224, and a local decarbonization process control module 230 configured for initiating, managing, directing, and/or controlling local aspects of a decarbonization process in association with remote initiation, management, or control of the decarbonization process by the remote decarbonization system 500. In an embodiment, the local decarbonization process control module 230 includes a communication module and data/event logger 232, an exhaust monitoring module 234; a temperature monitoring and/or control module 236; and a hydrogen flow management/regulation module 238. Each element of the local control unit 110 is coupled to a set of signal or data transfer pathways 195, such as a set of signal and/or data transfer buses.

Aspects of a Representative Implementation of an Engine Decarbonization Unit

Each hydrogen gas canister, cartridge, or cassette 300a-b can include or be a commercially available container, canister, cartridge, or cassette for storing hydrogen gas in solid state form, for instance, a hydrogen gas canister for storing up to approximately 70 grams of hydrogen, available from Whole Win (Beijing) Materials Sci. & Tech. Co., Ltd. (Room 405, Fangxing Building, No. 30 Xueyuan Road, Haidian District, Beijing 100083, P.R. China). Each hydrogen gas canister, cartridge, or cassette 300a-b typically includes a conventional or standard type of quick connect/disconnect interface, which facilitates rapid and reliable connection to and disconnection from the flow control unit 150, in a manner readily understood by one having ordinary skill in the relevant art. The set of temperature sensors 130a-b can include conventional thermocouples, which are disposed proximate to the hydrogen gas canisters, cartridges, or cassettes 300a-b, such as by way of appropriate positioning within one or more compartments in which the hydrogen gas canisters, cartridges, or cassettes 300a-b reside. The temperature control devices 140a-b can include a set of conventional heating/cooling elements or plates, and/or a set of conventional air temperature heating/cooling elements or units. The flow control/regulation unit 150 includes a set of conventional automatically adjustable (e.g., solenoid) valves for controlling and/or adjusting the flow of hydrogen gas as it is released from the hydrogen gas canisters, cartridges, or cassettes 300a-b. The hydrogen delivery line 152 can be made of one or more types of materials (e.g., Viton® or Buna-N) that are non-reactive with respect to hydrogen gas (H₂).

The exhaust sensor/analyzer 125 can include a conventional automotive certified exhaust sensor (e.g., air-to-fuel ratio, or lambda, sensor). In particular embodiments, exhaust gas sensor/analyzer 125 includes an exhaust gas analyzer for determining levels of one or more of O₂, CO, CO₂, NO_{R}, and possibly hydrocarbon content (HC) in an engine exhaust stream. In a representative implementation, the exhaust sensor/analyzer 125 includes or is an Automotive Microbench II (AMBII) sensor available from Sensors, Inc. (Sensors, Inc., Saline, Mich., USA). In such an implementation, the engine decarbonization unit 100 can include a reference or calibration gas cylinder (not shown) that facilitates calibration or “zeroing” of the exhaust gas sensor/analyzer, and the engine decarbonization unit's memory 200 can include an exhaust gas sensor/analyzer calibration module (not shown), such that the exhaust gas sensor/analyzer can be automatically (re)calibrated, in a manner readily understood by one having ordinary skill in the relevant art.

The local control unit 110 can include at least one microprocessor or microcontroller such as an Intel® Atom™ series processor (Intel Corp., Santa Clara, Calif. USA) as its processing unit 115, and can include 1 or more Gigabytes of memory 200, which can include one or more types of Random Access Memory (RAM) and Read-Only Memory (ROM). The data storage unit 112 can include a solid state memory based (e.g., flash memory) data storage device, and/or a disk drive, depending upon embodiment details. The network communication interface 175 can include a wireless Ethernet interface. Finally, the display device 108 can include or be a touch screen display, for presenting a decarbonization process GUI that enables decarbonization service personnel to interact with the engine decarbonization unit 100 in particular manners, and view or monitor aspects of an engine decarbonization process. In certain implementations, the processing unit 115, at least portions of the memory 200, and the display device 108 can be provided by a commercially available Human-Machine Interface (HMI) unit, such as an Intel® AHM-6087B.

Aspects of Representative Decarbonization Facility Service Desk Check-In Procedures

In a number of embodiments, when vehicle owner brings their vehicle 32 to a decarbonization facility 20, one or more decarbonization facility service personnel perform a vehicle check-in procedure using the decarbonization facility computer system 25, during which they enter, record, or capture an identifier such as a vehicle identification number (VIN) and/or a license plate number, and the vehicle's odometer reading. Such information is communicated to the remote decarbonization management system 500, which determines whether a record exists for this vehicle 32 in its database 520 indicating that this vehicle 32 has previously undergone a decarbonization process at this or an associated/related/equivalent decarbonization facility 20 that is linked with the remote decarbonization management system 500. If no prior record of this vehicle 32 exists in the database 520, the remote decarbonization management system 500 indicates such to the decarbonization facility computer system 25, and the decarbonization facility service personnel then enter, capture, or obtain additional information about the vehicle 32 using the decarbonization facility computer system 25. Such information includes the vehicle manufacturer, vehicle model, year of manufacture, engine type (e.g., gasoline/petrol/spark-ignited, or diesel), engine capacity (e.g., 1600 cc, 2000 cc, 2500 cc, etc . . . ), and other related information such as owner name, address, and telephone number. The service personnel then communicate this additional information to the remote decarbonization management system 500, which creates a database record corresponding to the vehicle 32.

If a prior record of the vehicle 32 exists in the database, or once a database record has been created for the vehicle 32, the remote decarbonization management system 500 determines a set of decarbonization process parameters for the vehicle engine 30, which in various embodiments includes or is an initial or default set of decarbonization process parameters. The initial set of decarbonization process parameters can be based upon one or more of vehicle engine type, engine capacity, and odometer reading.

The remote decarbonization management system 500, decarbonization facility computer system 25, and/or decarbonization facility service personnel can assign an engine decarbonization unit 100 to the engine 30 or vehicle 32 under consideration. In some embodiments, the initial set of decarbonization process parameters can additionally or alternatively be based upon one or more preliminary lambda values generated, measured, or obtained for the engine 30 while the engine is running. For instance, a set of preliminary lambda values can be a set of pre-decarbonization lambda values that is generated by the engine decarbonization unit 100 assigned to or associated with the engine 30/vehicle 32 by way of monitoring engine exhaust gas components before the controlled introduction of dry hydrogen gas into the engine 30 occurs. The engine decarbonization unit 100 can communicate the set of preliminary lambda values to the remote decarbonization management system 500 for purpose of determining the initial set of decarbonization process parameters. For instance, the remote decarbonization management system 500 can determine whether one or more preliminary lambda values fall within a given pre-decarbonization process lambda value range.

In view of the foregoing, the remote decarbonization management system 500 can determine the initial set of decarbonization process parameters for the engine 30 based upon one or more of vehicle engine type, engine capacity, odometer reading, and preliminary lambda value. The initial or default set of decarbonization process parameters can include, specify, or be an initial or default hydrogen gas flow rate, pressure, and/or volume. For example, the initial set of decarbonization process parameters can specify a predetermined or constant initial hydrogen gas flow rate or pressure; and an initial or default hydrogen gas flow duration, interval, and/or volume, for instance, a predetermined number of minutes. In a number of embodiments, the remote decarbonization management system's database 520 stores data (e.g., in table form) associating different engine types, engine capacities, odometer readings or odometer reading categories, and/or preliminary lambda values or preliminary lambda value ranges with particular initial or default decarbonization process parameters. Based upon information received from the decarbonization facility computer system 25 and/or the engine decarbonization unit 100 assigned to the engine 30/vehicle 32 under consideration, the remote decarbonization management system 500 can generate, retrieve, or look an appropriate initial set of decarbonziation process parameters.

The remote decarbonization management system 500 subsequently communicates this set of decarbonization process parameters (e.g., the initial/default decarbonization process parameters) to the decarbonization facility computer system 25, and/or the engine decarbonization unit 100 that the decarbonization facility computer system 25 has assigned to perform a decarbonization process upon the vehicle engine 30.

In some embodiments, the decarbonization facility computer system 25 generates a machine readable code such as a Quick Response (QR) code that includes or specifies this set of decarbonization parameters (e.g., the initial/default decarbonization process parameters) for this vehicle engine 30. The QR code can be printed out, for instance, in association with or as part of a service order (e.g., on a portion of a service order form), which is given to one or more decarbonization service personnel responsible for initiating or overseeing this vehicle's decarbonization process. The QR code on such a service order can be scanned by an engine decarbonization unit's QR code capture device 105, such that the engine decarbonization unit 100 can initiate a decarbonization process that is expected to be appropriate for the vehicle engine 30 under consideration given the vehicle's engine type, engine capacity, and current odometer reading.

Aspects of Representative Engine Decarbonization Unit Operation

In several embodiments, an engine decarbonization unit 100 undergoes an initialization procedure once it is turned on, which includes an authentication or authorization verification procedure in which the engine decarbonization unit 100 communicates with its corresponding network gateway 400 and/or the remote decarbonization management system 500, such that the remote decarbonization management system 500 can verify that the local engine decarbonization unit authorization code or ID stored within the memory 200 is valid. In some embodiments, the engine decarbonization unit 100 performs this authentication/authorization procedure prior to performing each decarbonization service routine, for instance, after scanning a QR code and prior to releasing hydrogen gas from a hydrogen gas canister 300a-b into the engine 30. If the authorization code or ID stored within its local memory 200 is valid, the remote decarbonization management system 500 authorizes, enables, or permits the engine decarbonization unit 100 to perform engine decarbonization processes; otherwise, subsequent communication between the engine decarbonization unit 100 and the network gateway 400 and/or the remote decarbonization process manager 500 can be disregarded or disabled, limiting the extent to which the engine decarbonization unit 100 can perform a decarbonization process or preventing the engine decarbonization unit 100 from performing a decarbonization process. In certain embodiments, if the authorization code or ID is invalid, the remote decarbonization management system 500 can disable the engine decarbonization unit 100.

In association with an initialization procedure, or prior to initiating hydrogen gas flow in association with an engine decarbonization process, the engine decarbonization unit 100 can determine a current temperature corresponding to the set of hydrogen canisters 300a-b, and can determine whether this current temperature is within an intended or acceptable temperature range (e.g., approximately 30 degrees Celsius, or between 25-35 or 20-40 degrees Celsius) to facilitate the predictable and/or controlled release or delivery of hydrogen from the set of hydrogen canisters 300a-b during a decarbonization process. If not, the engine decarbonization unit 100 can adjust the temperature of the hydrogen canisters 300a-b by way of heating or cooling the canisters 300a-b (e.g., heating or cooling the environment in which the canisters 300a-b reside), as appropriate, to establish and/or maintain the hydrogen gas canisters 300a-b at an intended or target temperature or within a target or appropriate temperature range.

The engine decarbonization unit 100 can additionally determine a hydrogen pressure and/or level or volume of hydrogen remaining in one or more hydrogen canisters 300a-b during the initialization procedure, prior to initiating hydrogen gas flow for an engine decarbonization process, during an engine decarbonization process, and/or after an engine decarbonization process, and can provide an indication to service personnel whether one or more of such canisters 300a-b require attention or replacement. In various embodiments, the engine decarbonization unit 100 includes multiple hydrogen canisters 300a-b, such that hydrogen gas can be discharged or sourced from one canister 300a,b when another canister 300b,a is empty or nearly empty, and possibly such that one hydrogen canister 300a,b can be replaced or swapped out (e.g., “hot swapped”) while the other 300b,a is in use to thereby minimize engine decarbonization unit downtime.

The engine decarbonization unit 100 can also present a current hydrogen canister temperature and hydrogen canister pressure/level/volume (e.g., by way of one or more visual or graphical icons) on the display screen 108, as part of the decarbonization GUI. In some embodiments, the engine decarbonization unit 100 can additionally determine a current humidity level corresponding to the hydrogen canisters 300a-b, for instance, in a compartment in which the hydrogen canisters 300a-b reside, by way of one or more humidity sensors (not shown).

The engine decarbonization unit 100 can communicate a pressure or level/volume of hydrogen in each hydrogen canister 300a-b, as well as corresponding hydrogen canister temperatures, to the remote decarbonization management system 500 at one or more times, to facilitate utilization monitoring/tracking by the remote decarbonization management system 500. In certain embodiments, the engine decarbonization unit 100 can correspondingly communicate hydrogen canister related humidity information to the remote decarbonization management system 500 at one or more times.

Representative Aspects of an Engine Decarbonization Process

After receiving the initial/default decarbonization process parameters provided or generated by the remote decarbonization management system 500, and possibly after performing any required authentication or authorization verification procedure, an engine decarbonization unit 100 can initiate the discharge or release of hydrogen gas from the hydrogen gas canister(s) 300a-b into the engine 30 for which the remote decarbonization management system 500 provided the initial/default decarbonization process parameters, during an initial phase of a decarbonization process. The initial phase of the decarbonization process can involve providing hydrogen gas into the engine 30 at a predetermined or constant/fixed flow rate and/or pressure, such as approximately 2.0, 2.5, or 3.0 standard liters per minute (SLPM), for a predetermined period of time, for instance, approximately 5.0 minutes (or alternatively, approximately 7.5 or 10 minutes).

The hydrogen gas flow rate, pressure, and/or volume selected for the initial phase of the engine decarbonization process can be selected based upon engine type, engine capacity, vehicle odometer reading, and/or a set of preliminary lambda values, for instance, by way of a lookup table stored in the remote decarbonization management system's database 520.

In various embodiments, during the decarbonization process, the engine decarbonization unit 100 samples or measures the levels of particular exhaust gas components (e.g., including O₂, CO, CO₂, NOₓ, and HC levels), and determines or calculates value of the engine's air-to-fuel ratio or lambda, in a manner readily understood by one having ordinary skill in the relevant art. The local control unit 110 can additionally display the values of lambda and/or the sampled levels of one or more exhaust gas components on the decarbonization GUI during the decarbonization process.

The local control unit 110 communicates at least some of the sampled lambda values (e.g., an average lambda value corresponding to each n second interval), and at least some of the sampled exhaust gas component levels (e.g., for each exhaust gas component under consideration, an average value corresponding to each q second interval), to the remote decarbonization management system 500, which can analyze the lambda values and exhaust gas component levels received from the engine decarbonization unit 100 during the decarbonization process.

During the initial phase of the engine decarbonization process, the remote decarbonization management system 500 can analyze engine combustion conditions, and characterize or define a set of initial or non-final engine combustion conditions. In several embodiments, prior to the end of the initial phase of the engine decarbonization process, based upon (a) how far lambda is away from a target or optimum value (e.g., 1.00) or how far outside of a target or optimum range lambda is (e.g., 1.00 +/−0.05, or 1.0 +/−0.03), and possibly (b) one or more rates of change in lambda values calculated during the initial phase of the decarbonization process, the remote decarbonization management system 500 determines (i) whether the engine 30 is running rich, lean, or under sufficiently optimum conditions, and/or (ii) one or more additional or updated sets of engine decarbonization process parameters, each of which specifies a hydrogen gas flow rate, pressure, and/or volume, which can be an adjusted or updated flow rate, pressure, and/or volume relative to a previously determined flow rate, pressure, and/or volume, respectively. The remote decarbonization management system 500 communicates each additional set of engine decarbonization process parameters to the engine decarbonization unit 100 during a second phase of the engine decarbonization process, which can last a predetermined period of time, for instance, 5-30 minutes (e.g., 10-20 minutes), depending upon engine type, engine capacity, odometer reading, and/or one or more lambda values determined during the initial phase of the decarbonization process.

In response to receiving each additional set of engine decarbonization process parameters, the engine decarbonization unit 100 adjusts the flow of hydrogen gas output by the hydrogen gas canister(s) 300a-b by way of the hydrogen flow control unit 150, as indicated or specified by the additional set of engine decarbonization process parameters.

A given adjusted or updated hydrogen gas flow rate is intended to provide an increased or decreased flow of hydrogen gas into the engine 30 in order to shift or establish the engine combustion conditions such that calculated lambda values are at least approaching the target or optimum lambda value or range (e.g., in an accelerating manner), or fall or remain within the target or optimum range. For instance, if current and/or recently calculated lambda values indicate that the engine 30 is running rich or lean, a hydrogen gas flow rate can be increased (e.g., by 10-50%); whereas if lambda values indicate that near optimal or optimal combustion conditions have been achieved, the hydrogen gas flow rate can be decreased (e.g., by 10-50%).

Prior to completion of the second phase of the decarbonization process, the remote decarbonization management system 500 determines whether an optional third or final decarbonization phase is required, which can involve providing a predetermined (e.g., constant) flow of hydrogen gas (e.g., at a flow of approximately 2.0 or 2.5 SLPM) into the engine 30 for a variable amount of time, for instance, an additional 2.5-15 minutes (e.g., an additional 5-10 minutes), depending upon factors such as engine type, engine capacity, odometer reading, time elapsed and/or distance traveled since the performance of a most recent prior engine decarbonization process, engine age, and/or one or more lambda values determined during the current and/or a prior engine decarbonization process. If the optional third or final decarbonization phase is to be performed, the remote decarbonization management system 500 communicates a final set of decarbonization process parameters to the engine decarbonization unit 100, which adjusts the hydrogen gas flow as indicated by the final set of decarbonization process parameters and maintains or approximately maintains this hydrogen gas flow during the final phase of the decarbonization process.

Representative Aspects of Remote Decarbonization Service Management System

In addition to (a) verifying that individual engine decarbonization units 100 associated with each decarbonization facility 20 are authorized for performing decarbonization processes, (b) maintaining a database 520 in which a decarbonization history of each decarbonization process performed on a given engine 30 or vehicle 32 is stored, and (c) determining decarbonization process parameters for each decarbonization process to be performed upon each engine/vehicle 30, 32 brought into a decarbonization facility 20 and communicating such decarbonization process parameters to an appropriate engine decarbonization unit 100 within the decarbonization facility 20 (e.g., by way of a generating a QR code), the remote decarbonization management system 500 can additionally generate or retrieve data that can be used to provide or generate a comprehensive report corresponding to a most recent and/or one or more historical engine decarbonization processes performed upon a vehicle 32, and can communicate such data to a decarbonization facility's computer system 25 to facilitate the generation of decarbonization results summaries/reports for vehicle owners. In some embodiments, the remote decarbonization management system 500 provides an Internet based vehicle owner interface (e.g., accessible by way of a web browser) by which vehicle owners can selectively or selectably access, retrieve, or download decarbonization process histories and/or data corresponding to their vehicles 32.

Additionally, the remote decarbonization management system 500 can track or monitor the utilization of each engine decarbonization unit 100 across multiple decarbonization facilities 100, and can generate decarbonization unit utilization statistics/reports based upon such tracking or monitoring. Such utilization tracking or monitoring can facilitate efficient hydrogen gas supply chain logistics management, as well as periodic engine decarbonization unit maintenance scheduling.

Over time, the remote decarbonization management system's database 520 can store decarbonization information corresponding to thousands (e.g., several or many thousands) of different machines or vehicles 32. In various embodiments, the remote decarbonization management system 500 can analyze information stored within its database 520 to access, retrieve, or determine/generate historical engine decarbonization information (e.g., historical data and/or statistics) corresponding to different types of engines 30, different types of vehicles 32, different vehicle manufacturers, and various odometer reading ranges. In a number of embodiments, the remote decarbonization management system 500 provides an Internet based vehicle manufacturer interface (e.g., accessible by way of a web browser) by which vehicle manufacturers can selectively or selectably access, retrieve, or download decarbonization process histories and/or data corresponding to the vehicles 32 they have manufactured, and/or categorical types of vehicles 32 they and/or others have manufactured.

While the foregoing detailed description was directed to decarbonization processes performed upon vehicles 32 having internal combustion engines 30, one having ordinary skill in the relevant art will understand that decarbonization processes can be performed on essentially any type of machine 32 having an internal combustion engine 30. For a machine 32 that lacks an odometer, information indicating an engine age and/or an amount of time elapsed since the performance of a most recent engine decarbonization process upon the machine's engine 30 can be used to facilitate the determination of an initial/default set of decarbonization process parameters.

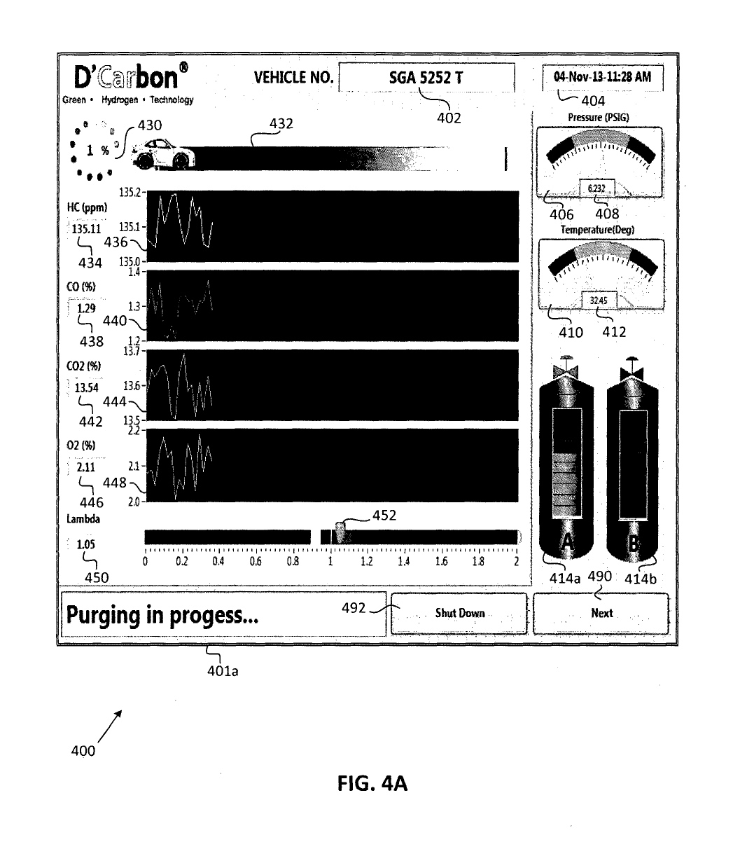

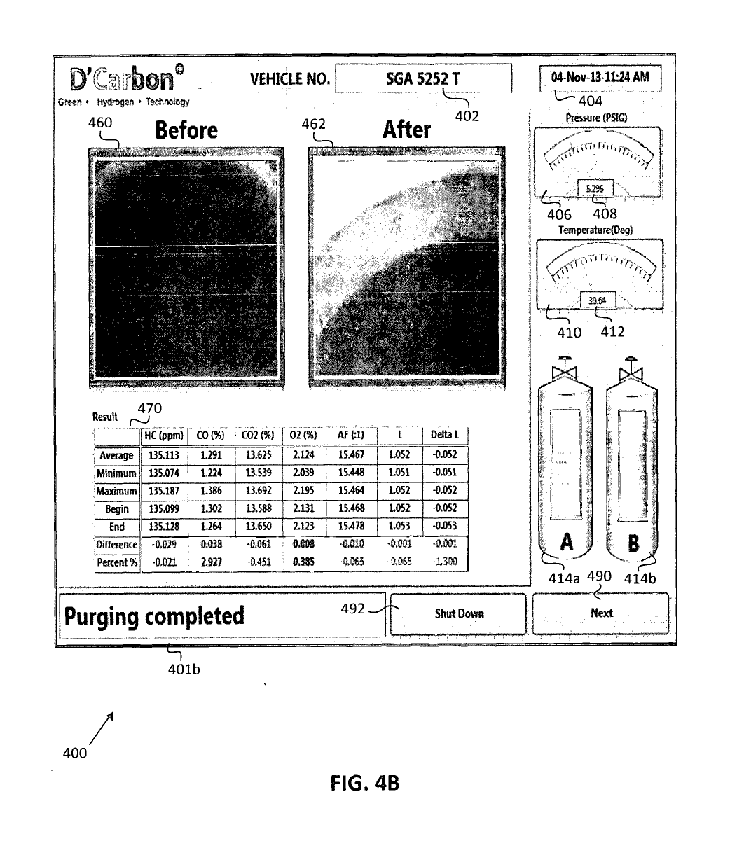

FIGS. 4A and 4B are representative illustrations showing portions of a decarbonization graphical user interface (GUI) 400 in accordance with an embodiment of the present disclosure. The decarbonization GUI 400 includes multiple screens by which decarbonization related information can be presented or provided to decarbonization facility service personnel and/or vehicle owners. Each screen includes a number of visual or graphical objects that are presented on the display device 108, in a manner readily understood by one having ordinary skill in the relevant art. Depending upon a display screen under consideration, at least some of such visual or graphical objects can be updated in a manner that is correlated with or which indicates engine decarbonization process progress and/or results.

For instance, in a representative embodiment indicated in FIG. 4A, the decarbonization GUI 400 includes a first screen 401a that includes a vehicle identifier 402; a time/date identifier 404; a graphical hydrogen canister pressure icon 406 and a corresponding hydrogen pressure readout 408 corresponding to an active or currently selected hydrogen gas canister 300a; a graphical hydrogen canister temperature icon 410 and a corresponding hydrogen temperature readout 412 corresponding to the hydrogen gas canisters 300a-b; graphical hydrogen gas canister icons 414a-b corresponding to the hydrogen gas canisters 300a-b, which graphically indicate an estimated hydrogen gas level or quantity remaining in the hydrogen gas canisters 300a-b; a decarbonization progress/time remaining readout 430 and a corresponding graphical decarbonization progress indicator 432; a current/recent sampled HC level value readout 434 and a corresponding graphical HC level display window 436; a current/recent sampled CO value readout 434 and a corresponding graphical CO level display window 436; a current/recent sampled CO₂ sampled value readout 434 and a corresponding graphical CO₂ level display window 436; a current/recent sampled O₂ sampled value readout 434 and a corresponding graphical O₂ level display window 436; plus a current/recent calculated lambda value readout 450 and a corresponding graphical (e.g., slider-type) current lambda value versus target lambda value icon. Finally, the first screen 401 a includes a next screen selection button 490, and a shut down/stop button 402.

As indicated in FIG. 4B, the representative decarbonization GUI 400 can further include a second screen 401b that includes particular elements displayed in the first screen 401, as well as a “before” window 460 in which a borescope image showing combustion chamber surfaces of an engine 30 prior to the performance of a decarbonization process upon the engine 30 is displayed or displayable; an “after” window 462 in which a borescope image showing combustion chamber surfaces of the engine 30 after the performance of the decarbonization process upon the engine 30 is displayed or displayable; and a “results” table 470 indicating levels (e.g., average, minimum, and maximum sampled values) of particular exhaust gas components and calculated lambda values at the beginning and the end of the engine decarbonization process, as well as corresponding beginning versus end differences corresponding to such exhaust gas component levels and calculated lambda values (e.g., on absolute and/or relative/percentage bases).

Aspects of particular embodiments of the present disclosure address at least one aspect, problem, limitation, and/or disadvantage associated with exiting engine decarbonization systems or techniques. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, components, processes, or alternatives thereof, may be desirably combined into other different systems, components, processes, and/or applications. In addition, various modifications, alterations, and/or improvements may be made to various embodiments that are disclosed by a person of ordinary skill in the art within the scope of the present disclosure.

1.-38. (canceled)

39. A method for decarbonizing engines, comprising:
determining an initial set of decarbonization process parameters for a first engine;
performing a first engine decarbonization process upon the first engine, the first engine decarbonization process comprising:
introducing dry hydrogen into the first engine while the first engine is running, in accordance with the initial set of first engine decarbonization process parameters;
automatically measuring first engine exhaust gas components while dry hydrogen is introduced into the first engine; and
automatically determining a set of lambda values based upon the measured exhaust gas components while dry hydrogen is introduced into the first engine, each lambda value corresponding to an air-to-fuel ratio for the first engine.

40. The method of claim 39, wherein introducing dry hydrogen into the first engine comprises releasing dry hydrogen from a dry hydrogen source into the first engine, rather than introducing oxyhydrogen into the first engine.

41. The method of claim 39, wherein the initial set of engine decarbonization process parameters are selected from the group consisting of a dry hydrogen flow rate, pressure, volume, a first time period based upon at least some of first engine type, first engine capacity, and first engine odometer reading.

42. The method of claim 39, further comprising:
adjusting a flow rate of dry hydrogen sourced from a dry hydrogen source to establish an initial dry hydrogen flow rate or pressure in accordance with the initial set of first engine decarbonization parameters; and
determining a temperature of a dry hydrogen source from which the dry hydrogen is introduced into the first engine; and
adjusting the temperature of the dry hydrogen source before and/or during the first engine decarbonization process to establish or maintain a dry hydrogen flow rate or pressure in accordance with the initial set of first engine decarbonization process parameters.

43. The method of claim 39, further comprising:
determining an updated set of first engine decarbonization process parameters based upon at least some of the determined lambda values, wherein the updated set of first engine decarbonization process parameters are selected from the group consisting of updated dry hydrogen flow rate, pressure, a second time period based upon first engine type, first engine capacity, first engine odometer reading, and/or one or more determined lambda values determined during introduction of dry hydrogen into the first engine in accordance with the initial set of first engine decarbonization process parameters; and
continuing the first engine decarbonization process by introducing dry hydrogen into the first engine in accordance with the updated set of first engine decarbonization process parameters, wherein continuing the first engine decarbonization process in accordance with the updated set of first engine decarbonization parameters shifts first engine combustion conditions such that determined lambda values are at least approaching a target lambda value range, or remain within the target lambda value range.

44. The method of claim 39, wherein determining the initial set of first engine decarbonization process parameters for the first engine decarbonization process comprises:
receiving at a remote engine decarbonization management system first engine information including at least one of first engine type, first engine capacity, and first engine odometer reading; automatically determining the initial set of first engine decarbonization process parameters by the remote engine decarbonization management system in accordance with the first engine information; and automatically communicating the initial set of first engine decarbonization process parameters from the remote engine decarbonization management system to a first local engine decarbonization unit configured for (a) introducing dry hydrogen into the first engine in accordance with the initial set of first engine decarbonization process parameters and (b) measuring first engine exhaust gas components.

45. The method of claim 44, wherein determining the initial set of first engine
decarbonization process parameters further comprises:
determining a set of preliminary lambda values for the first engine; and
communicating the set of preliminary lambda values to the remote engine decarbonization management system as part of the first engine information.

46. The method of claim 44, further comprising:
performing a second engine decarbonization process upon a second engine, the second engine decarbonization process comprising:
determining an initial set of second engine decarbonization process parameters;
introducing dry hydrogen into the second engine while the second engine is running, in accordance with the initial set of second engine decarbonization process parameters, wherein introducing dry hydrogen into the second engine and measuring second engine exhaust gas components is performed by a second local engine decarbonization unit distinct from the first local engine decarbonisation unit;
measuring second engine exhaust gas components while dry hydrogen is introduced into the second engine; and
determining a set of lambda values based upon the measured exhaust gas components while dry hydrogen is introduced into the second engine, each lambda value corresponding to an air-to-fuel ratio for the second engine.

47. The method of claim 46, wherein the first and second engine decarbonization procedures are performed simultaneously.

48. The method of claim 46, wherein the first local engine decarbonization unit stores a first authorization code and the second local engine decarbonization unit stores a second authorization code, and wherein each of the first and second authorization codes is communicable to the remote decarbonization management system for automatic verification of the first local engine decarbonization unit and the second local engine decarbonization unit, respectively, by the remote decarbonization management system.

49. The method of claim 46, further comprising storing in a database associated with the remote engine decarbonization management system historical engine decarbonization information.

50. The method of claim 49, further comprising providing an Internet based vehicle manufacturing interface by which a vehicle manufacturer can access decarbonization process histories corresponding to vehicles they have manufactured, and/or categorical types of vehicles they and/or other manufacturers have manufactured.

51. A system for decarbonization engines, comprising:
a set of engine decarbonization units, each engine decarbonization unit comprising: a hydrogen flow regulation unit couplable to a source of dry hydrogen;
a hydrogen delivery line coupled to the hydrogen flow regulator and configured for introducing dry hydrogen into an engine;
an engine exhaust gas analyzer configured for measuring engine exhaust gas components and determining a set of corresponding lambda values, each lambda value corresponding to an air-to-fuel ratio of the engine; and
a control unit configured for controllably introducing dry hydrogen into the engine while the engine is running in accordance with an initial set of engine decarbonization process parameters, wherein the initial set of engine decarbonization process parameters in based upon at least some of engine type, engine capacity, engine odometer reading, and a set of preliminary lambda values corresponding to the engine.

52. The system of claim 51, wherein the control unit of each engine decarbonization unit is further configured for adjusting a dry hydrogen flow rate into the engine in order to shift engine combustion conditions such that determined lambda values are at least approaching a target lambda value range, or remain within the target lambda value range.

53. The system of claim 51, wherein each engine decarbonization unit further comprises a set of temperature sensors and a temperature regulation device for controlling a temperature of the source of dry hydrogen.

54. The system of claim 51, wherein the set of engine decarbonization units comprises a plurality of engine decarbonization units, and wherein the system further comprises a remote engine decarbonization management system configured for network communication with each engine decarbonisation unit, the network communication comprising:
communicating from each engine decarbonization unit to the remote engine decarbonization management system a set of lambda values corresponding to an engine associated with the engine decarbonization unit, including lambda values determined while dry hydrogen is introduced into the engine as part of a decarbonization process; and
communicating from the remote engine decarbonization management system to each engine decarbonization unit a set of updated engine decarbonization process parameters specifying a dry hydrogen flow rate for shifting combustion conditions of the engine associated with the engine decarbonization unit such that determined lambda values for the engine are at least approaching a target lambda value range, or remain within the target lambda value range.

55. The system of claim 54 wherein the network communication further comprises:
communicating engine information to the remote engine decarbonization management system, the engine information including at . least some of engine type, engine capacity, engine odometer reading, and a set of preliminary lambda values corresponding to the engine associated with the engine decarbonization unit; and
communicating from the remote engine decarbonization management system to each engine decarbonization unit a set of initial engine decarbonization process parameters based upon the engine information.

56. The system of claim 54, wherein the remote engine decarbonization management system is configured for verifying an authorization code corresponding to each engine decarbonization unit.

57. The system of claim 54, further comprising a database coupled to the remote engine decarbonization management system, and wherein the remote engine decarbonization management system is configured to store engine decarbonization histories corresponding to different types of engines in the database.

58. The system of claim 57, wherein the remote engine decarbonization management system provides an Internet based vehicle manufacturing interface by which a vehicle manufacturer can access decarbonization process histories corresponding to vehicles they have manufactured, and/or categorical types of vehicles they and/or other manufacturers have manufactured.

59. A system for decarbonization engines, comprising:
a set of engine decarbonization units, each engine decarbonization unit comprising: a hydrogen flow regulation unit couplable to a source of dry hydrogen;
a hydrogen delivery line coupled to the hydrogen flow regulator and configured for introducing dry hydrogen into an engine;
an engine exhaust gas analyzer configured for measuring engine exhaust gas components and determining a set of corresponding lambda values, each lambda value corresponding to an air-to-fuel ratio of the engine; and
a control unit configured for controllably introducing dry hydrogen into the engine while the engine is running in accordance with a set of engine decarbonization process parameters, wherein the set of engine decarbonization process parameters is based upon at least one of engine type, engine capacity, engine odometer reading, and a set of lambda values corresponding to the engine.

60. The system of claim 59, wherein each engine decarbonization unit further comprises a set of temperature sensors and a temperature regulation device for controlling a temperature of the source of dry hydrogen.

61. The system of claim 59, wherein the source of dry hydrogen for each engine decarbonization unit comprises a set of solid state hydrogen gas canisters, cartridges, or cassettes, and wherein each engine decarbonization unit further comprises a housing configured for removably receiving the set of solid state hydrogen gas canisters, cartridges, or cassettes and coupling the set of solid state hydrogen gas canisters, cartridges, or cassettes to the hydrogen flow regulation unit.

62. The system of claim 59, wherein each engine decarbonization unit further comprises a display device.

63. The system of claim 59, wherein each engine decarbonization unit further comprises a digital code reader, wherein the digital code reader comprises a QR code reader.

64. The system of claim 59, wherein the system further comprises a decarbonization facility computer system having a digital code generation unit, wherein the digital code generation unit comprises a QR code generation unit.

65. The system of claim 59, wherein the set of engine decarbonization units comprises a plurality of engine decarbonization units, and wherein the system further comprises a remote engine decarbonization management system coupled to each engine decarbonization unit by way of a computer network.

66. The system of claim 65, wherein the set of engine decarbonization units comprises a first set of engine decarbonization units located at a first decarbonization facility, and a second set of engine decarbonization units located at a second decarbonization facility that is geographically distinct from the first engine decarbonization facility.

67. The system of claim 66, wherein the system further comprises:
a first network gateway corresponding to the first decarbonization facility and configured for communication with the first set of engine decarbonization units and the remote engine decarbonization management system; and
a second network gateway corresponding to the second decarbonization facility and configured for communication with the second set of engine decarbonization units and the remote engine decarbonization management system.

68. The system of claim 66, wherein the system further comprises a database coupled to the remote engine decarbonization management system, the database storing engine decarbonization history information associated with each of the first set of engine decarbonization units and the second set of engine decarbonization units.
